(19) United States
(12) Patent Application Publication
(10) Pub. No.: US 2006/0138952 A1
(43) Pub. Date: Jun. 29, 2006

(54) Sheet-like desiccating member, organic El panel, and organic El panel manufacturing method

(75) Inventor: Akihiko Yamaguchi, Yamagata (JP)

Correspondence Address: ARENT FOX PLLC, 1050 CONNECTICUT AVENUE, N.W., SUITE 400, WASHINGTON, DC, 20036, US

(73) Assignee: TOHOKU PIONEER CORPORATION

(21) Appl. No.: 11/315,202

(22) Filed: Dec. 23, 2005

(30) Foreign Application Priority Data
Dec. 28, 2004 (JP) 2004-380533

(51) Int. Cl. H05B 33/00; H05B 33/04; H05B 33/10

(52) U.S. Cl. 313/512; 313/506; 445/25

(57) ABSTRACT

It is an object of the invention to improve the productivity of an operation for bonding a sheet-like desiccating member onto a sealing cover, which sheet-like desiccating member is formed by removing its central portion so as to avoid an undesired contact between the desiccating member provided within the sealing cover and a laminated body forming an organic EL element, while still ensuring that an organic EL panel containing these members has only a thin thickness. The organic EL panel is provided by forming on a substrate an organic EL laminated body formed by interposing at least an organic layer between a pair of electrodes, followed by attaching a sealing cover for shielding the organic EL laminated body from an outside air. In particular, a sheet-like desiccating member is provided within the sealing cover in a manner such that the desiccating member is spaced apart from the organic EL laminated body. Specifically, the sheet-like desiccating member has a central portion-removed pattern, which central portion, before being removed, faces the organic EL laminated body and is connected with an outside portion.

### BACKGROUND OF THE INVENTION

The present invention relates to a sheet-like desiccating member, an organic EL panel, and a method of manufacturing the organic EL panel.

The present application claims priority from Japanese Application No. 2004-380533, the disclosure of which is incorporated herein by reference.

An organic EL (Electroluminescent) panel comprises a plurality of organic EL elements forming an essential structure for the panel. Each organic EL element is obtained by forming a first electrode on a substrate, anorganic layer containing a luminescent layer consisting of an organic compound on the first electrode, and a second electrode on the organic layer. These organic EL elements serve as unit light emission elements which are arranged in a predetermined manner on the substrate.

However, it is known that such an organic EL panel suffers from a problem that once the foregoing organic layer and electrodes are exposed to an outside air, the characteristics of the EL panel will degrade. This is because moisture will invader into interfaces each formed between the organic layer and the first or second electrode, thus hampering electron injection, producing dark spots which form non-luminescent areas, and causing corrosion of electrodes. In order to improve the stability and durability of organic EL elements, it is extremely important to use a sealing technique which can shield the organic EL elements from the outside air. Here, a sealing technique commonly used is to bond, by virtue of an adhesive agent, a sealing cover capable of covering electrodes and an organic layer onto a substrate mounting the electrodes and the organic layer.

FIGS. 1(a) and 1(b) illustrate a conventional technique (Japanese Unexamined Patent Application Publication No. Hei 9-148066) in relation to the above-mentioned organic EL panel. FIG. 1(a) is an explanatory view showing the structure of an organic EL panel 1. As shown, the organic EL panel (organic EL element) 1 comprises: a glass substrate 2; a laminated body (an organic EL laminated body) consisting of an ITO electrode (first electrode) 3, an organic luminescent layer (organic layer) 4 and a cathode (second electrode) 5; a glass sealing cover (sealing member) 7; a desiccating member 8; and a sealing material (adhesive agent) 9.

The desiccating member 8 is provided after bonding the sealing cover 7 so as to remove an initial moisture existing within the sealing cover 7 and a later moisture generated (with the passing of time) from the organic EL laminated body 6 or invaded through the sealing material 9. Particularly, the organic layer partially forming the organic EL element is weak with heat so that it is impossible to remove the moisture by performing a heating treatment before a sealing treatment. For this reason, with an organic EL panel using the foregoing organic EL element, the above-mentioned desiccating member 8 has to be disposed within the sealing cover 7. In this regard, Japanese Unexamined Patent Application Publication No. Hei 9-148066 has disclosed that the desiccating member 8 is a compound capable of chemically absorbing a moisture and at the same time keeping itself in a solid state, and that such a desiccating member 8 is fixed on to the inner surface of the sealing cover 7 by virtue of an adhesive material, in a manner such that it is spaced apart from the laminated body 6.

FIG. 1(b) is an explanatory view showing some problems existing in the above-discussed prior art. As shown, with the foregoing organic EL panel it has been confirmed that its sealing cover 7 will get bent due to an external force or due to a pressure difference between the interior and the exterior of the sealing cover 7, bringing about a result that the central portion 8A of the desiccating member 8 becomes convex towards the laminated body 6. Moreover, since the desiccating member 8 will absorb a moisture or the like due to certain kind of material forming such desiccating member, there will be an increase in the volume of such desiccating member, resulting in a problem that the central portion 8A of the desiccating member 8 will expand into a convex shape.

Usually, an organic EL panel is required to be thin in its thickness and an internal space within the sealing cover 7 is also required to be as thin as possible. On the other hand, a certain thickness of the desiccating member 8 has to be ensured so as to assure an adequate dehumidifying function. Consequently, an interval between the laminated body 6 and the desiccating member 8 of an organic EL panel will have to be set narrow, and this will cause a problem shown in FIG. 1(b). Namely, once the central portion 8A of the desiccating member 8 facing the laminated body 6 expands into a convex shape towards the laminated body 6, the desiccating member 8 will get into contact with the laminated body 6. As a result, some deterioration factors such as moisture absorbed by the desiccating member 8 will shift towards the laminated body 6 due to a surface tension, thus deteriorating the electrodes and the organic layer of the laminated body 6, hence remarkably shortening the working life of the organic EL panel.

In order to avoid the above problem, the applicant of the present application has suggested in Japanese Unexamined Patent Application Publication No. 2004-296202 that an organic EL panel be made thin in its thickness, while the desiccating member 8 provided within the sealing cover 7 be made not to contact the organic EL laminated body 6 which forms an organic EL element. In detail, a recess portion is formed on the desiccating member 8 and such a recess portion faces the organic EL laminated body 6. Alternatively, it is possible to employ an annular desiccating member 8 with the central portion thereof removed.

The above-mentioned desiccating member is usually obtained by forming a desiccating material into a sheet-like member in advance, followed by being bonded on to the sealing cover 7 after being processed into a desired shape by punching. On the other hand, if it is desired to improve mass production, an elongate desiccating material will have to be formed as a belt-like blank material which is at first rolled up and then drawn out so as to be cut (using a cutting die) into a plurality of desiccating members each having a desired pattern, followed by bonding each desiccating member onto a sealing cover 7.

The above-discussed sheet-like desiccating member will be described in more detail with reference to FIGS. 2(a1) to 2(d2). Here, FIGS. 2(a1) to 2(d1) are plan views and FIGS. 2(a2) to 2(d2) are cross sectional views taken along A-A lines of FIGS. 2(a1) to 2(d1). As shown, a sheet-like desiccating member 10 comprises an exfoliation sheet 11 and a desiccant layer 13 for physically or chemically absorbing a moisture, with the desiccant layer 13 bonded onto the exfoliation sheet 11 through an adhesive layer 12 (refer to FIG. 2(a2)). After the adhesive layer 12 and the desiccant layer 13 mounted on the exfoliation sheet 11 have been formed into a desired shape, they are stripped from the exfoliation sheet 11 and tightly bonded on to a sealing cover 7 through a similar adhesive layer.

However, if the above-described sheet-like desiccating member 10 is used and if such a desiccating member is in an annular configuration with its central portion removed, there will occur the following problems.

Namely, during a desiccating member bonding step using the sheet-like desiccating member 10, an annular pattern P is formed by making cuts C1 and C2 as shown in FIG. 2(b1) and FIG. 2(b2). Then, unnecessary portions are stripped from the exfoliation sheet 11 so that only an annular pattern P is left as shown in FIG. 2(d1) and FIG. 2(d2). Afterwards, a desiccating member having the annular pattern P is attracted by a suction head or the like and bonded onto a sealing cover. In doing this, a first step is to remove an unnecessary portion P1 located on the outside of the annular pattern P shown in FIG. 2(b1) and FIG. 2(b2), thereby obtaining an intermediate state shown in FIG. 2(c1) and FIG. 2(c2). Subsequently, a second step is carried out to remove an unnecessary portion P2 located on the inner side of the annular pattern P shown in FIG. 2(c1) and FIG. 2(c2), thereby obtaining a completed state shown in FIG. 2(d1) and FIG. 2(d2). As a result, this method involves two steps for removing unnecessary portions, i.e., one step more than a method in which a rectangular desiccating member is formed and bonded onto a sealing cover. Accordingly, this method has a low productivity and thus incurs an increased manufacturing cost.

On the other hand, if it is desired to use only one step to remove the above-mentioned unnecessary portions P1 and P2, it is allowed to form the cut C2 deeply in a step shown in FIG. 2(b1) and FIG. 2(b2) until the exfoliation sheet 11 is cut through, with the unnecessary central portion P2 removed together with the corresponding portion of the exfoliation sheet 11. In this manner, since it is necessary to change the depths of the cuts C1 and C2, and since the central portion of the exfoliation sheet 11 has to be removed, the strength of the exfoliation sheet 11 will be insufficient, rendering it impossible to correctly maintain the shape of the annular pattern P.

### SUMMARY OF THE INVENTION

The present invention has been accomplished in order to solve the above problem and it is an object of the invention to improve the operability of an operation for bonding a sheet-like desiccating member onto a sealing cover, which sheet-like desiccating member is formed by removing its central portion so as to avoid an undesired contact between the desiccating member provided within the sealing cover and a laminated body forming an organic EL element, while still ensuring that an organic EL panel containing these members has only a thin thickness.

In order to achieve the above object, a sheet-like desiccating member, an organic EL panel, and an organic EL panel manufacturing method are characterized by at least the following aspects.

According to one aspect of the present invention, there is provided a sheet-like desiccating member having a desiccant layer for physically or chemically absorbing moisture, and having a desired pattern formed by making a cut. Specifically, the sheet-like desiccating member has a central portion-removed pattern, which central portion, before being removed, is connected with an outside portion.

According to another aspect of the present invention, there is provided an organic EL panel obtained by forming on a substrate an organic EL laminated body formed by interposing at least an organic layer between a pair of electrodes, and including a sealing cover for shielding the organic EL laminated body from an outside air. In particular, a desiccating member is provided within the sealing cover, in a manner such that the desiccating member is spaced apart from the organic EL laminated body. Further, the desiccating member is a sheet-like member having a desired pattern formed by making a cut, which desired pattern presents a central portion-removed shape, which central portion faces the organic EL laminated body. Moreover, the desired pattern is formed in a manner such that the central portion, before being removed, is connected with an outside portion.

According to a further aspect of the present invention, there is provided a method of manufacturing an organic EL panel obtained by forming on a substrate an organic EL laminated body formed by interposing at least an organic layer between a pair of electrodes, and including a sealing cover for shielding the organic EL laminated body from an outside air. Specifically, when forming a sheet-like desiccating member having a desired pattern formed by making a cut, such a cut having the desired pattern is formed in a manner such that an unnecessary central portion is connected with an unnecessary outside portion, and the unnecessary central portion and the unnecessary outside portion are removed in one step to obtain the sheet-like desiccating member having the desired pattern. Specifically, the sheet-like desiccating member having the pattern is bonded on to the sealing cover.

### BRIEF DESCRIPTION OF THE DRAWINGS

These and other objects and advantages of the present invention will become clear from the following description with reference to the accompanying drawings, wherein:

FIGS. 1(a) and 1(b) are explanatory sectional views showing a prior art;

FIGS. 2(a1) to 2(d2) are plan and sectional views showing a sheet-like desiccating member;

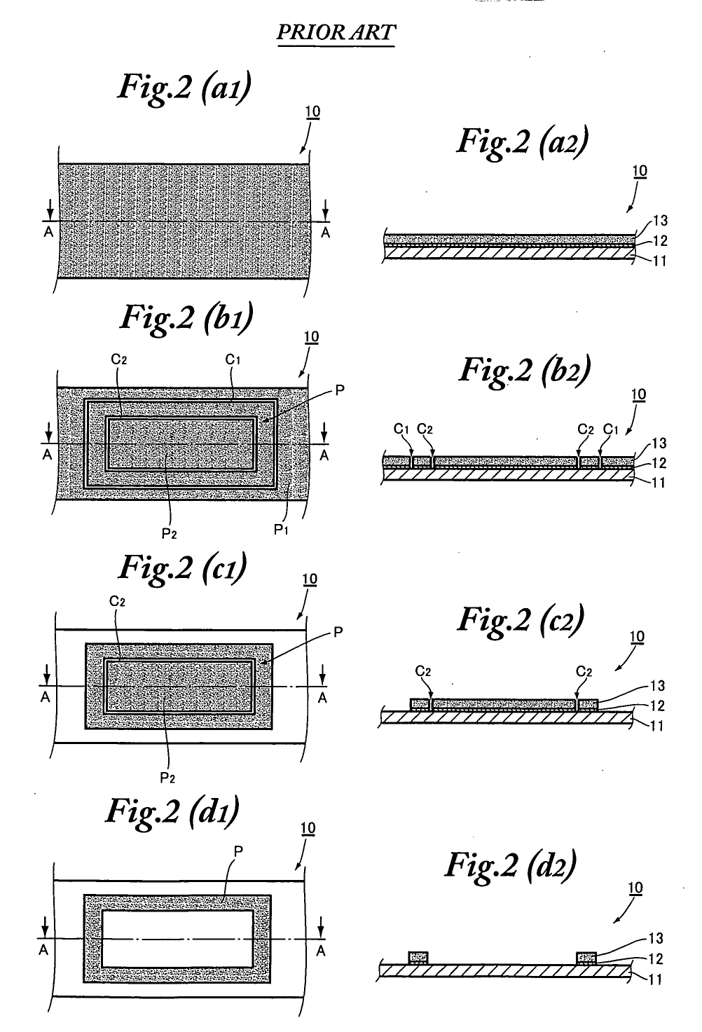

FIGS. 3(a1) and 3(b1) are plan views and FIGS. 3(a2) and 3(b2) are sectional views taken along A-A lines of FIGS. 3(a1) and 3(b1), showing a sheet-like desiccating member formed according to an embodiment of the present invention;

FIGS. 4(a) to 4(g) are explanatory views showing sheet-like desiccating members of different patterns formed according to different embodiments of the present invention;

FIG. 5(a) is a longitudinally sectional view and FIG. 5(b) is B-B sectional view, showing the structure of an organic EL panel formed according to one embodiment of the present invention; and

FIGS. 6(a) and 6(b) are flow charts showing a method of manufacturing an organic EL panel according to one embodiment of the present invention.

### DETAILED DESCRIPTION OF THE PREFERRED EMBODIMENTS

Next, embodiments of the present invention will be described with reference to the accompanying drawings (however, the same portions as those used in the prior art will be represented by the same reference numerals and same explanations will be omitted).

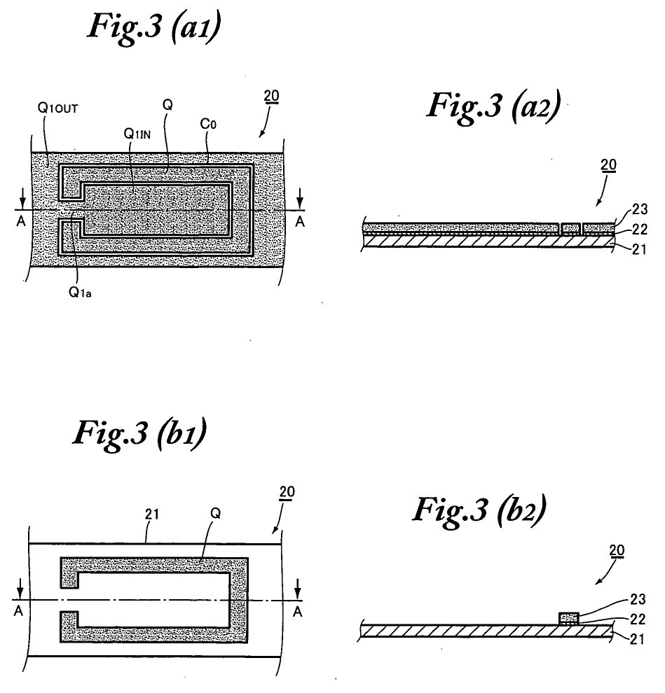

FIGS. 3(a1) to 3(b2) are explanatory views showing a sheet-like desiccating member 20 formed according to one embodiment of the present invention. Here, FIGS. 3(a1) and 3(b1) are plan views and FIGS. 3(a2) and 3(b2) are cross sectional views taken along A-A lines of FIGS. 3(a1) and 3(b1). As shown, the sheet-like desiccating member 20 comprises an exfoliation sheet 21 and a desiccant layer 23 for physically or chemically absorbing moisture, with the desiccant layer 13 bonded onto the exfoliation sheet 11 through an adhesive layer 22. In this way, it is possible to form the desiccating member 20 into a desired pattern by making an appropriate cut thereon. Here, although the above description has been focused on an example involving the exfoliation sheet 21, it is also possible to form the sheet-like desiccating member 20 consisting only of the desiccating layer 23 without the exfoliation sheet 21.

Subsequently, in order to prevent the central portion of the sheet-like desiccating member 20 from getting into contact with an organic EL laminated body 6 (such contact is usually caused due to a possible bending of a sealing cover after the sheet-like desiccating member 20 has been bonded onto the sealing cover of an organic EL panel), the sheet-like desiccating member 20 formed according to one embodiment of the present invention has a pattern Q with the central portion thereof removed. Further, in order to form such a pattern Q, one cutting die is used to form one continuous cut C0 so as to form the desired pattern Q, in a manner such that an unnecessary central portion Q1IN and an unnecessary outside portion Q1OUT are connected with each other at a connecting portion Q1a.

In this way, when it is desired to form only the pattern Q shown in FIG. 3(b1) and FIG. 3(b2), since it is possible to integrally remove the foregoing unnecessary portions Q1IN, Q1OUT and Q1a, only one step is required to complete such removal. Therefore, it is allowed to complete the removal using a process which is one step fewer than the prior art involving the formation of an annular pattern P. Further, similar to the foregoing annular pattern P, if the present invention is applied to an organic EL panel, it is exactly possible to prevent the central portion of the sheet-like desiccating member (provided within the sealing cover) from getting into contact with the organic EL laminated body.

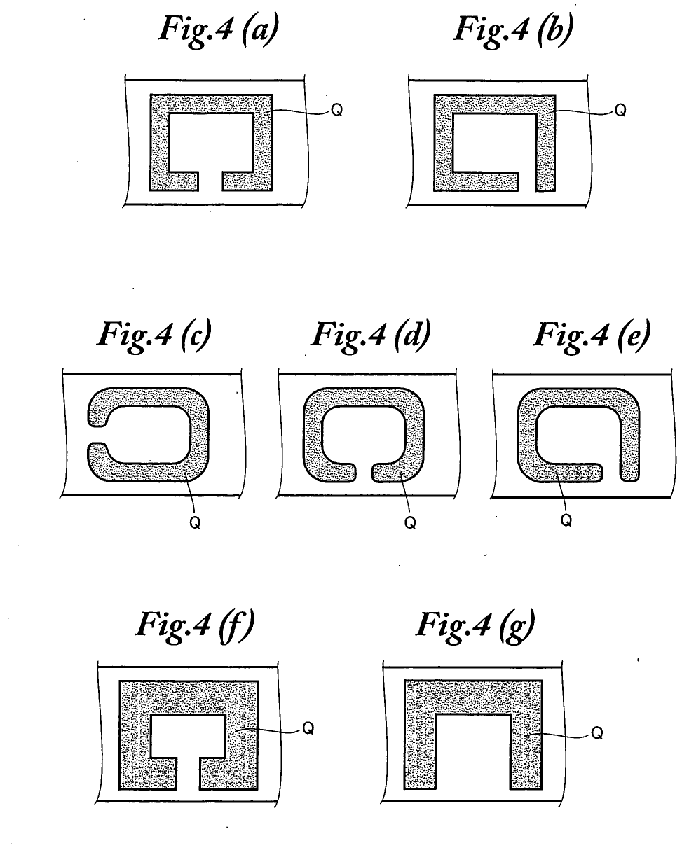

Moreover, the pattern Q of the sheet-like desiccating member 20 according to the present embodiment of the present invention should not be limited to an inverted rectangular C-shaped image shown in FIG. 3(b1). Instead, it is possible to form various other shapes shown in FIGS. 4(a) to 4(g) and achieve the same object, function and effect. FIGS. 4(a) and 4(b) show that it is possible to change the position of the connecting portion Q1a connecting an unnecessary central portion Q1IN with an unnecessary outside portion Q1OUT, and that such a connecting portion Q1a can be located at any position. FIGS. 4(c) to 4(e) show that it is possible to form an R on each corner of the pattern Q. FIG. 4(f) shows that it is possible to increase the width of the desiccating member and reduce the area of the central portion to be removed. However, each of the above examples shows an annular pattern Q with one portion thereof removed. FIG. 4(g) shows that it is possible to increase the width of the connecting portion Q1a, allowing one side of the rectangle to serve as the connecting portion Q1a, thereby forming a gate-like pattern.

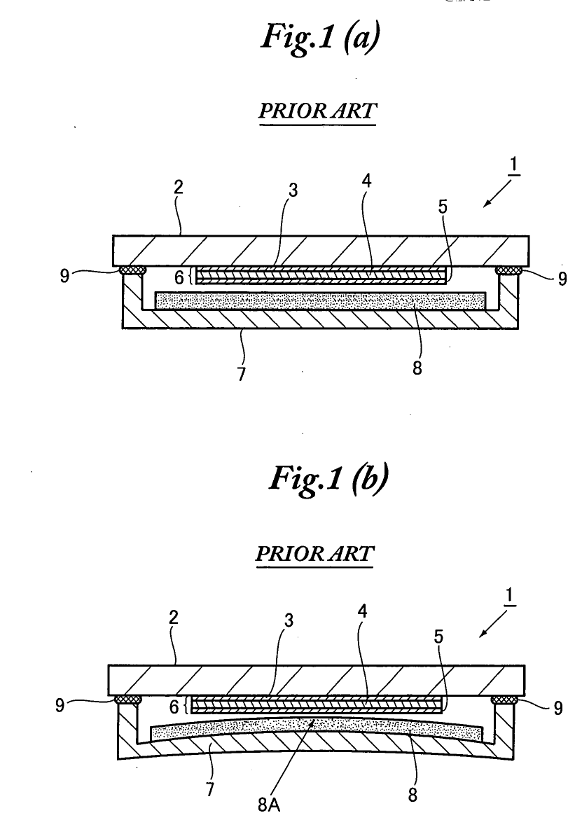

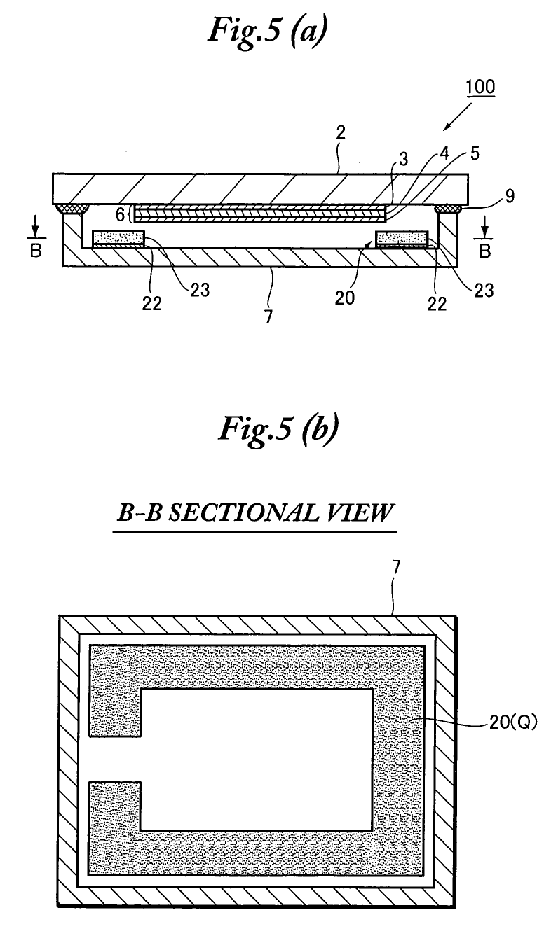

FIGS. 5(a) and 5(b) are explanatory views showing the structure of an organic EL panel 100 formed according to one embodiment of the present invention. In detail, FIG. 5(a) is a longitudinal sectional view and FIG. 5(b) is a cross sectional view taken along B-B line of FIG. 5(a). Similar to the above-described prior art shown in FIG. 1(a), an organic EL panel 100 comprises a substrate 2 and an organic EL laminated body 6 formed by laminating a first electrode 3, an organic layer 4 and a second electrode 5, thereby forming an organic EL element by interposing at least an organic layer between a pair of electrodes. Further, a sealing cover 7 is bonded on to the substrate 2 through an adhesive layer 9, so as to cover the organic EL laminated body 6 in the internal space of the sealing cover 7, thereby shielding the organic EL laminated body 6 from the outside air. Moreover, a desiccating member 20 is provided within the sealing cover 7 but spaced apart from the organic EL laminated body 6.

Here, the sheet-like desiccating member 20 is one shown in FIG. 3(b1), with its sheet-like desiccating layer 23 bonded on to the inner surface of the sealing cover 7 through an adhesive layer 22, so as to remove (by absorption) an initial moisture existing within the sealing space as well as a moisture coming from the organic EL laminated body 6 with the passing of time or an outer moisture gradually invading through the adhesive layer 9. In fact, it is allowed to use any type of desiccating material capable of physical or chemical absorption, provided that it has a function of removing (by absorption) any of the above-mentioned moistures.

The pattern Q of the sheet-like desiccating member, as shown in FIGS. 3 and 4, is annular with its central portion and part of its annular ring portion removed. In fact, the sheet-like desiccating member 20 is disposed on the inner surface of the sealing cover 7 in a manner such that the central portion of the desiccating member 20 faces the organic EL laminated body 6 formed on the substrate 2. In this way, even if the sealing cover 7 will be bent somehow or even if the sheet-like desiccating member 20 absorbs moisture and thus expands in its volume, it is still possible to constantly keep an interval between the sheet-like desiccating member 20 and the surface of the organic EL laminated body 6, thereby making it possible to avoid an undesired contact between the surface of the sheet-like desiccating member 20 and the surface of the organic EL laminated body 6.

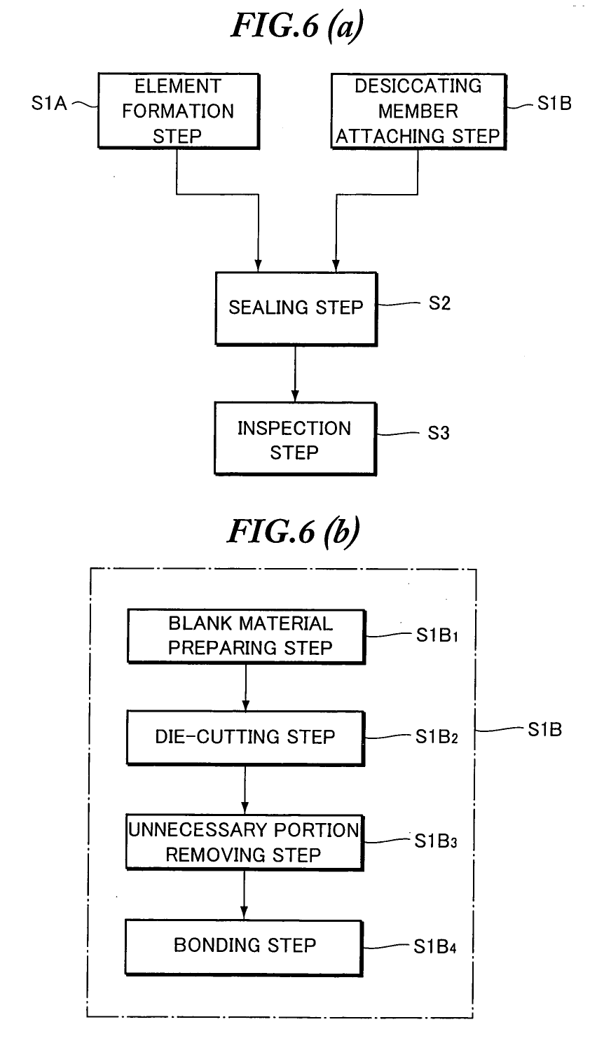

Next, description will be given to explain a method of manufacturing an organic EL panel according to an embodiment of the present invention. FIGS. 6(a) and 6(b) are flow charts briefly showing several steps involved in the method. As shown, at first, element formation step S1A is carried out to form an organic EL laminated body 6 by laminating a first electrode 3, an organic layer 4, and a second electrode 5 on a substrate 2, thereby obtaining an organic EL element formed by interposing at least an organic layer between a pair of electrodes. Here, what are actually used are a film formation step and a pattern formation step which are well-known in forming an organic EL element. In practice, a plurality of organic EL elements may be arranged in a dot matrix arrangement, or in any one of other desired patterns. Alternatively, a single one organic EL element having a predetermined pattern may be disposed in a predetermined manner.

On the other hand, a desiccating member attaching step S1B is carried out to attach, on to the sealing cover 7, the sheet-like desiccating member 20 having a predetermined pattern formed by making cut. As shown in FIG. 6(b), the desiccating member attaching step S1B is at first to prepare a belt-like blank material for sheet-like desiccating member (blank material preparation step S1B₁). Here, if the blank material is in the form of a rolled belt, it has to be stretched and set in a die-cutting apparatus.

Next, a die-cutting step S1B₂ is carried out using the die-cutting apparatus. Here, a cut having a pattern shown in FIG. 3 or FIG. 4 is formed by using one cutting die. Namely, an appropriate cut is made in the blank material so that the pattern Q is formed with its unnecessary central portion removed. Specifically, the pattern Q is formed in a manner such that the unnecessary central portion Q1IN is connected with the unnecessary outside portion Q1OUT. If the blank material is in the form of a belt, a plurality of such cuts can be formed in the longitudinal direction of the belt-like blank material.

Subsequently, the unnecessary central portion QIN and the unnecessary outside portion Q1OUT are removed (unnecessary portion removing step S1B₃), while the sheet-like desiccating member 20 having the pattern Q is bonded on to the inner surface of the sealing cover 8 through an adhesive layer 22 (bonding step S1B₄). If the blank material to be used is in the form of a belt, unnecessary central portions Q1IN and the unnecessary outside portions Q1OUT can be integrally removed along the longitudinal direction of the blank material. Further, if the bonding step S1B₄ is automated, a suction head can be used to pick up each sheet-like desiccating member 20 having the pattern Q and move the same on to the inner surface of a sealing cover 7, followed by pressing the desiccating member against the inner surface of the sealing cover and thus completing the bonding step.

Next, a sealing step S2 is carried out by applying an adhesive agent 9 to the edge portion of the substrate 2 or the bonding portion of the sealing cover 7, so that the sealing cover 7 is bonded on to the substrate 2 so as to seal up the organic EL laminated body 6. Afterwards, an inspection step S3 is performed if necessary, thereby obtaining an organic EL panel according to the above embodiment of the present invention.

The organic EL panel and the method of manufacturing the organic EL panel according to the above embodiment of the present invention can be summarized as the following.

Firstly, an organic EL laminated body 6 formed by interposing at least an organic layer between a pair of electrodes is formed on the substrate 2, followed by providing the sealing cover 7 for shielding the organic EL laminated body 6 from the outside atmosphere, and providing the sheet-like desiccating member 20 within the sealing cover 7 but spaced apart from the organic EL laminated body 6. Here, the sheet-like desiccating member 20 has a pattern Q with its central portion (facing the organic EL laminated body 6) removed. In fact, the pattern Q is formed in a manner such that an unnecessary central portion Q1IN and an unnecessary outside portion Q1OUT are connected with each other.

The manufacturing method comprises: a cutting step which is carried out when forming a sheet-like desiccating member having a pattern Q, in a manner such that an unnecessary central portion Q1IN and an unnecessary outside portion Q1OUT a reconnected with each other; a desiccating member formation step for forming a sheet-like desiccating member having the pattern Q, by removing in one step the unnecessary central portion Q1IN and the unnecessary outside portion Q1OUT; and a bonding step for bonding the sheet-like desiccating member having the pattern Q on to a sealing cover 7.

In this way, if the pattern Q is formed with its central portion (facing the organic EL laminated body 6) removed, even if a convex portion will occur on the surface of the sealing cover 7 due to a possible bending of the sealing cover, it is still possible to avoid a deterioration or a shortened life of the organic EL laminated body 6 (which will otherwise be caused by an undesired contact between the desiccating member and the organic EL laminated body), without causing the surface of the sheet-like desiccating member 20 to get into contact with the surface of the organic EL laminated body 6. Moreover, when the sheet-like desiccating member 20 having the pattern Q is attached to the sealing cover 7, since it is possible to integrally remove the unnecessary central portion Q1IN and the unnecessary outside portion Q1OUT, it can be made exactly sure to improve the productivity of the method of manufacturing an organic EL panel.

Secondly, the pattern Q is an annular one containing an unconnected portion and is formed by using one cutting die. In this way, when a cut forming the pattern Q is to be formed in the blank material for sheet-like desiccating member, it is allowed to carry out only one die-cutting step using only one cutting die, thereby ensuring an acceptable productivity of the method of manufacturing an organic EL panel.

Thirdly, each sheet-like desiccating member 20 is characterized in that it is produced from a belt-like blank material, and that a plurality of patterns Q can be formed along the belt-like blank material, further that unnecessary central portions and unnecessary outside portions can be integrally removed along the belt-like blank material. In this way, if it is desired to attach a plurality of sheet-like desiccating members 20 (each having a desired pattern) to a plurality of sealing covers 7, it is allowed to form a plurality of patterns Q in the belt-like blank material. Moreover, since it is allowed to remove the unnecessary portions (with respect to pattern Q) in only one step, it is possible to realize an efficient manufacturing with a high productivity in mass production.

Next, detailed examples will be given as embodiments of the present invention to explain the essential elements forming the invention.

[Sheet-like Desiccating Member] As the desiccating layer 23 forming the sheet-like desiccating member 20, it is possible to laminate a molded layer containing a moisture absorbent and a resin material on an exfoliation sheet, or use a desiccating member in the form of a single layer.

As the moisture absorbent, it is allowed to use a material at least having a function capable of absorbing moisture. In particular, it is preferable to use a compound capable of chemically absorbing a moisture and at the same time keeping itself in a solid state even if it has absorbed a moisture. As such a compound, it is preferable to use a metal oxide, an inorganic acid metal salt, and an organic acid metal salt. Particularly, it is preferable to use at least one of alkaline earth metal oxide and sulfate. As an alkaline earth metal oxide, it is allowed to use calcium oxide (CaO), barium oxide (BaO), magnesium oxide (MgO) or the like. As a sulfate, it is allowed to use lithium sulfate (Li₂SO₄), sodium sulfate (Na₂SO₄), calcium sulfate (CaSO₄), magnesium sulfate (MgSO₄), cobalt sulfate (COSO₄), gallium sulfate (Ga₂(SO₄)₃), titanium sulfate (Ti₂(SO₄)), nickel sulfate (NiSO₄). In addition, as a moisture absorbent it is also possible to use an organic material having a moisture absorbability.

On the other hand, as a resin component it is allowed to use any sort of resin material without limitation, provided that it does not hamper the removal of moisture from the desiccant. Preferably, it is desired to use a highly air-permeable material (namely, a material having a low air barrier function, particularly an air-permeable resin). As such a material, it is allowed to use a high molecular material such as a polyolefine resin, a polyacrylic resin, a polyacrylonitrile resin, a polyamide resin, a polyester resin, an epoxy resin, and a polycarbonate resin. In the present invention, it is preferable to use a polyolefine resin. In more detail, it is possible to use not only a polyethylene, a polypropylene, a polybutadiene, and a polyisoprene, but also their copolymers.

Although the content of a moisture absorbent and a resin component may be appropriately designed according to the type of these materials, it is preferable to use 30-85 wt % of a moisture absorbent and 70-15 wt % of a resin component, with an assumption that a total amount including the moisture absorbent and the resin component is 100 wt %. Preferably, it is desired to use 40-80 wt % of a moisture absorbent and 60-20 wt % of a resin component. More preferably, it is desired to use 50-70 wt % of a moisture absorbent and 50-30 wt % of a resin component.

Here, the moisture absorbent molded layer can be formed by uniformly mixing together various components and forming an obtained mixture into a desired shape. At this time, it is preferable to sufficiently dry a moisture absorbent, a gas absorbent and the like in advance before they are mixed together. Further, when a moisture absorbent, a gas absorbent and the like are mixed with a resin component, they can be heated into a molten state.

[Organic EL Element] In the following, description will be given in detail to explain the structure and materials of an organic EL element obtained by forming on a substrate 2 an organic EL laminated body 6 which is formed by laminating a first electrode 2, an organic layer 4 and a second electrode 5.

(a) Substrate:

As the substrate 2, it is preferable to use a flat plate having a transparency. As a material for forming the transparent flat plate, it is possible to use glass or plastic.

(b) Electrode:

If an organic EL panel is a bottom emission type which produces light from the substrate 2 side, the first electrode 3 will serve as an anode and consist of a transparent electrode, while the second electrode 5 will serve as a cathode and consist of a metal electrode. Here, an appropriate anode material may be ITO, ZnO or the like and such an anode can be formed by a film formation method such as vapor deposition and sputtering. On the other hand, an appropriate cathode material may be a metal, a metal oxide, a metal fluoride, an alloy or the like (each having a small work function). In more detail, the cathode may be in a single-layer structure formed of Al, In, Mg or the like, or in a laminated structure formed of LiO2/Al or the like, using a film formation method such as vapor deposition and sputtering.

(c) Organic Layer:

If the first electrode serves as an anode and the second electrode serves as a cathode, the organic layer 4 will be in a laminated structure including positive hole transporting layer/luminescent layer/electron transporting layer. Each of the luminescent layer, the positive hole transporting layer and the electron transporting layer may be only one layer structure or in a laminated multi-layer structure. Moreover, it is also allowed to omit either or both of the positive hole transporting layer and the electron transporting layer, with the remaining layer being only the luminescent layer. Further, if necessary, it is also possible to insert an organic functional layer such as a positive hole injecting layer, an electron injecting layer, a positive hole barrier layer and an electron barrier layer into the organic layer 4.

A material for forming the organic layer 4 can be suitably selected according to an actual application of organic EL element. Examples will be given below but will not form any limitation to the present invention.

The positive hole transporting layer may be formed by any well-known compound, provided that it has a high positive hole movability. In more detail, it is possible to use an organic material which may be a porphyrin compound such as copper phthalocyanine, an aromatic tertiary amine such as 4′4-bis[N-(1-naphthyl)-N-phenylamino]-biphenyl (NPB), a stilbene compound such as 4-(di-p-tolylamino)-4′-[4-(di-p-tolylamino)styryl] stilbenzene, a triazole derivative and a styrylamine compound. Moreover, it is also possible to use a high molecular material formed by dispersing, in a high molecular material such as a polycarbonate material, a low molecular organic material for transporting positive holes.

The luminescent layer may be formed by any known luminescent material. In more detail, it is possible to use an aromatic dimethyldene compound such as 4,4′-bis (2,2′-diphenyl vinyl)-biphenyl (DPVBi), a styryl benzene compound such as 1,4-bis(2-methyl styryl) benzene, a triazole derivative such as 3-(4-biphenyl)-4-phenyl-5-t-butylphenyls-1,2,4-triazole (TAZ), an anthraquinone derivative, a luminescent organic material such as a fluorenone derivative, a luminescent organic metal compound such as (8-hydroxy quinolynate) aluminum complex (Alq₃), a high molecular material such as a polypara phenylene vinylene (PPV) system, a polyfluorene system, and a polyvinyl carbazole (PVK) system or the like, an organic material capable of making use of a phosphorescence from triplet excitons such as a platinum complex and an iridium complex (Japanese Unexamined Patent Application Publication No. 2001-520450). In fact, it is possible for the luminescent layer to be formed either by a luminescent material only, or also contain a positive hole transporting material, an electron transporting material, an additive (a donor, an acceptor or the like) or a luminescent dopant. On the other hand, it is also possible for such a material to be dispersed in a high molecular material or in an inorganic material.

An electron transporting layer can be formed by any known compound, provided that it has a function of transporting the electrons injected from the cathode to the luminescent layer. In more detail, it is allowed to use an organic material such as a nitro-substituted fluorenone derivative and an anthraquinodimethan derivative, a metal complex of 8-quinolinol derivative, a metal phthalocyanine or the like.

The above-mentioned positive hole transporting layer, the luminescent layer, and the electron transporting layer can be formed in a wet process which may be a coating method such as spin coating and dipping, or a printing method such as ink-jet and screen printing. On the other hand, it is also possible to use a dry process such as vapor deposition and laser transfer.

(d) Sealing Cover:

The sealing cover 7 can be formed by any desired material, preferably glass or metal.

(e) Adhesive Agent:

The adhesive agent 9 may be a thermal-setting type, a chemical-setting type (two-liquid mixing), or a light (ultraviolet)-setting type, and can be formed by an acryl resin, an epoxy resin, a polyester, or a polyolefine. In particular, it is preferable to use an ultraviolet-setting epoxy resin to form the adhesive agent 9. In practice, an appropriate amount (about 0.1-0.5 we %) of spacers having a size of 1-100 μm (preferably, glass or plastic) is mixed into the adhesive agent, and then a dispenser is used to apply the adhesive agent to desired surfaces.

(f) Various types of organic EL panels:

An organic EL laminated body 6 may be formed by single one organic EL element or by a plurality of organic EL elements serving as a plurality of pixels arranged in a desired pattern.

If an organic EL laminated body 6 contains a plurality of organic EL elements serving as a plurality of pixels arranged in a desired pattern, light emission may involve single one color or two or more colors. In order to provide an organic EL panel capable of light emission involving a plurality of colors, it is possible to use: a discriminative painting method which forms luminescent layers of two or more colors, including a method of forming three kinds of luminescent layers corresponding to colors RGB; a method in which a single color (white or blue) luminescence functional layer is combined with a color conversion layer formed by a color filter or a fluorescent material (CF manner, CCM manner); a photo breeching method which realizes a multiple light emission by emitting an electromagnetic wave or the like to the light emission area of a single color luminescent functional layer; and a laser transfer method in which several kinds of low molecular materials of different luminescent colors are formed in advance into different films and then transferred on to one substrate by means of thermal-transfer using a laser. Moreover, as an organic EL element driving method, it is allowed to use a passive driving manner or an active driving manner.

While there has been described what are at present considered to be preferred embodiments of the present invention, it will be understood that various modifications may be made thereto, and it is intended that the appended claims cover all such modifications as fall within the true spirit and scope of the invention.

1. A sheet-like desiccating member having a desiccant layer for physically or chemically absorbing moisture, and having a desired pattern formed by making a cut,
wherein the sheet-like desiccating member has a central portion-removed pattern, which central portion, before being removed, is connected with an outside portion.

2. The sheet-like desiccating member according to claim 1, wherein the desiccant layer is formed on an exfoliation sheet through an adhesive agent.

3. The sheet-like desiccating member according to claim 1, wherein said pattern is formed by one cutting die which makes said cut.

4. The sheet-like desiccating member according to claim 1, wherein said pattern is an annular pattern with one portion thereof removed.

5. An organic EL panel obtained by forming on a substrate an organic EL laminated body formed by interposing at least an organic layer between a pair of electrodes, and including a sealing cover for shielding the organic EL laminated body from an outside air,
wherein a desiccating member is provided within the sealing cover, in a manner such that the desiccating member is spaced apart from the organic EL laminated body,
wherein said desiccating member is a sheet-like member having a desired pattern formed by making a cut, which desired pattern presents a central portion-removed shape, which central portion faces the organic EL laminated body,
wherein said desired pattern is formed in a manner such that the central portion, before being removed, is connected with an outside portion.

6. The organic EL panel according to claim 5, wherein said pattern is an annular pattern with one portion thereof removed.

7. A method of manufacturing an organic EL panel obtained by forming on a substrate an organic EL laminated body formed by interposing at least an organic layer between a pair of electrodes, and including a sealing cover for shielding the organic EL laminated body from an outside air,
wherein when forming a sheet-like desiccating member having a desired pattern formed by making a cut, such a cut having the desired pattern is formed in a manner such that an unnecessary central portion is connected with an unnecessary outside portion, and said unnecessary central portion and said unnecessary outside portion are removed in one step to obtain the sheet-like desiccating member having the desired pattern,
wherein the sheet-like desiccating member having said pattern is bonded on to the sealing cover.

8. The method according to claim 7, wherein the cut having the desired pattern is formed by using one cutting die.

9. The method according to claim 7 or 8, wherein the sheet-like desiccating member is formed from a belt-like blank material, and a plurality of said patterns are formed along the belt-like blank material.

10. The method according to claim 9, wherein unnecessary central portions and unnecessary outside portions are removed integrally along the belt-like blank material.

11. The sheet-like desiccating member according to claim 2, wherein said pattern is formed by one cutting die which makes said cut.

12. The sheet-like desiccating member according to claim 2, wherein said pattern is an annular pattern with one portion thereof removed.

13. The sheet-like desiccating member according to claim 3, wherein said pattern is an annular pattern with one portion thereof removed.

14. The sheet-like desiccating member according to claim 11, wherein said pattern is an annular pattern with one portion thereof removed.

15. The method according to claim 8, wherein the sheet-like desiccating member is formed from a belt-like blank material, and a plurality of said patterns are formed along the belt-like blank material.

16. The method according to claim 15, wherein unnecessary central portions and unnecessary outside portions are removed integrally along the belt-like blank material.
